(19) United States
(12) Patent Application Publication
(10) Pub. No.: US 2002/0123594 A1
(43) Pub. Date: Sep. 5, 2002

(54) Polyurethane prepolymers and polyurethane elastomers based on 1,4-naphthalene diisocyanate

(76) Inventors: Andreas Hoffmann, Koln (DE); Joachim Zechlin, Dusseldorf (DE); James-Michael Barnes, Breitscheit (DE); Hartmut Nefzger, Pulheim (DE); Lothar Duda, Dusseldorf (DE); Bodo Temme, Baytown, TX (US)

Correspondence Address: JAMES FRANKS, Bayer Corporation, 100 Bayer Road, Pittsburgh, PA, 15205, US

(21) Appl. No.: 09/998,452

(22) Filed: Nov. 30, 2001

(30) Foreign Application Priority Data
Dec. 6, 2000 (DE) 10060473.0

(51) Int. Cl. C08G 18/00

(52) U.S. Cl. 528/44

(57) ABSTRACT

Polyurethane prepolymers and polyurethane elastomers based on 1,4-naphthalene are described. Methods of preparing the polyurethane prepolymers and elastomers are also described. Molded articles capable of withstanding high mechanical stresses, prepared from the polyurethane prepolymers and/or polyurethane elastomers of the present invention, are further described.

### CROSS REFERENCE TO RELATED PATENT APPLICATIONS

The present patent application claims priority under 35 U.S.C. 119 (a)-(d) of German Patent Application Serial No. 100 60 473.0, filed Dec. 6, 2000.

### FIELD OF THE INVENTION

The present invention relates to polyurethane prepolymers and to polyurethane elastomers based on 1,4-naphthalene diisocyanate, to a method of producing them, and to the use thereof for the production of mouldings which can withstand high mechanical stresses.

### BACKGROUND OF THE INVENTION

Polyurethane elastomers (PU elastomers) have long been known and are described in numerous patent and literature publications.

A review of PU elastomers and the properties and uses thereof is given, for example, in the Kunststoff-Handbuch, Volume 7, Polyurethanes, 3rd revised Edition, Volume 193, edited by Prof. Dr. G. W. Becker and Prof. Dr. D. Braun (Carl-Hanser-Verlag, Munich, Vienna).

For the production of polyurethane elastomers which exhibit high-grade mechanical properties, 1,5-naphthalene diisocyanate (1,5-NDI) has proved useful as an isocyanate component for said elastomers.

Since 1,5-NDI cannot readily be handled on account of its relatively high melting point, there has been no lack of attempts aimed at replacing 1,5-NDI by diisocyanates which are more readily handled and which are less expensive, without thereby impairing the favourable range of properties which are obtained for PU elastomers based on 1,5-NDI.

In this connection, mention should be made in particular of German Patents DE-A1-19 627 907, DE-A1-19 628 145 and DE-A1-19 628 146, according to which attempts are made to replace 1,5-NDI by other diisocyanates which are claimed to be suitable for producing solid or cellular PU elastomers which have a comparatively favourable range of mechanical properties.

Both when using 1,5-NDI as the isocyanate synthesis component for PU-elastomers and when using the diisocyanates proposed according to the aforementioned German Patents, namely 4,4′-stilbene diisocyanate, 3,3′-dimethoxy-4,4′-diisocyanato-diphenyl and 1,4-phenylene diisocyanate, with at least one additional aromatic diisocyanate selected from the group comprising toluene diisocyanate and diphenylmethane diisocyanate, there is the disadvantage, as before, that the colour stability of elastomers produced using said isocyanate synthesis components cannot yet be considered to be satisfactory. Moreover, there is still a need for an improvement in the shelf life of prepolymers based on the aforementioned isocyanate synthesis components when polyurethane elastomers are produced by the prepolymer method. According to the teaching of EP-A1-1024156, the disadvantage of low colour stability can be eliminated by the use of durol diisocyanate, whereupon products are obtained which also exhibit high-grade mechanical properties.

For reasons of processability (viscosity), prepolymers based on 1,5-naphthalene diisocyanate have to be produced and stored at relatively high temperatures. This is a consequence of the comparatively high melting point of 125° C. of the isocyanate, and of its relatively slight solubility in the prepolymer itself.

### SUMMARY OF THE INVENTION

The object of the present invention is to provide new prepolymers for the production of solid or cellular polyurethane elastomers, which have a reduced viscosity compared with that of prepolymers based on 1,5-naphthalene diisocyanate. At the same time, the polyurethane elastomers produced based on the prepolymers according to the invention should exhibit high-grade mechanical properties comparable with those of polyurethane elastomers which are produced based on 1,5-naphthalene diisocyanate.

In accordance with the present invention, there is provided a polyurethane prepolymer prepared from a reaction mixture comprising:

a) at least one high molecular weight polyhydroxyl compound with a number average molecular weight of 500 to 10,000 and a functionality of at least 1.94;

b) 1,4-naphthalene diisocyanate; and

c) optionally at least one of, (i) a low molecular weight chain extender and (ii) a crosslinking agent, each of (i) and (ii) independently having at least two hydroxyl groups and a number average molecular weight of 18 to 499,

wherein said polyurethane prepolymer has a content of free isocyanate groups of 1 to 19% by weight, based on the total weight of said polyurethane prepolymer.

In accordance with the present invention, there is further provided a polyurethane elastomer prepared from a reaction mixture comprising:

a) at least one high molecular weight polyhydroxyl compound with a number average molecular weight of 500 to 10,000 and a functionality of at least 1.94;

b) 1,4-naphthalene diisocyanate;

c) at least one of (i) a low molecular weight chain extender and (ii) a crosslinking agent, each of (i) and (ii) independently having at least two hydroxyl groups and a number average molecular weight of 18 to 499; and

d) optionally foaming agents,

wherein said reaction mixture has an NCO/(active hydrogen groups) index of from 90 to 130.

As used herein and in the claims, the term “free isocyanate” refers to unreacted isocyanate groups (i.e., —NCO groups) that are capable of reacting with active hydrogen groups, such as hydroxyl groups, to form linkages, such as urethane linkages (i.e., —NH—C(O)—O—).

Other than in the operating examples, or where otherwise indicated, all numbers expressing quantities of ingredients, reaction conditions, etc. used in the specification and claims are to be understood as modified in all instance by the term “about.”

### DETAILED DESCRIPTION OF THE INVENTION

The NCO/(active hydrogen group) index is to be understood here to mean the characteristic number which describes the molar ratio of the NCO groups used to the active hydrogen groups (e.g. OH groups) used which are reactive with NCO. Thus an equivalent amount of NCO groups and active hydrogen groups (e.g. OH groups) which are reactive with NCO corresponds to an NCO/(active hydrogen group) index of 100. Active hydrogen group means a group which contains an active hydrogen atom, for example hydroxyl groups or amino groups which are capable of reacting with NCO-groups.

High molecular weight polyhydroxyl compounds which are particularly suitable for use as reactant (a) in the present invention include those with a number average molecular weight of 800 to 4000, most preferably 1000 to 3500, and a functionality (e.g., a hydroxyl functionality) of 1.8 to 3, most preferably 1.94 to 2.25.

In principle, all polyhydroxyl compounds which are used in polyurethane chemistry are suitable as high molecular weight polyhydroxyl compounds. Polyether polyols, polyester polyols and polycarbonates which contain hydroxyl groups are particularly suitable.

The polyester-, polyether- and polycarbonate polyols can be used either individually or in admixture with each other. Suitable polyester-, polyether- and polycarbonate polyols which can be used for the synthesis of the PU elastomers according to the invention are listed in detail in DE-A1-19 627 907, on page 4 and page 5, for example.

The polyester components which are preferably used are those which are synthesised from succinic acid or adipic acid and ethylene glycol, diethylene glycol, 1,4-butanediol or 1,6-hexanediol, most preferably those which are synthesised from adipic acid and ethylene glycol. Polylactones, preferably polycaprolactones, can also be used either individually or optionally in admixture with the above polyadipates and succinates.

The preferred polyether polyols which may be used include polyoxytetramethylene glycols, as well as polypropylene oxide polyols, which are produced by what is termed the KOH method, and also those which are obtained by what is termed the DMC method. Both these methods are described, for example, by J. L. Schuchardt and S. D. Harper, 32nd Annual Polyurethane Technical Marketing Conference, Oct. 1-4, 1989, pages 360-364.

Molecules which contain at least two hydroxyl groups and which have molecular weights of 18 to 499 are suitable as (c)(i) low molecular weight chain extenders and/or (c)(ii) crosslinking agents. Representative examples thereof include: ethylene glycol, diethylene glycol, propylene glycol, butylene glycol, etc., as well as water, which is used for cellular elastomers. Triols can also be used in small amounts (e.g., in amounts of from 0 to 15 percent molar equivalents, based on the total molar equivalents of (c)) and can be used either individually or in admixture with bifunctional components.

The chain extenders (c)(i) and crosslinking agents (c)(ii) can be used either individually or in admixture with each other, wherein the use of different chain extenders and crosslinking agents, as well as the use of the aforementioned high molecular weight polyhydroxyl compounds (a), depends on the desired range of mechanical properties of the PU elastomers to be produced.

The PU elastomers according to the invention, which are based on 1,4-naphthalene diisocyanate, can be obtained either as solid elastomers or in cellular form.

In order to adjust the mechanical properties, for example the hardness, of the PU elastomers, synthesis components (a), (b) and (c) can be varied over wide quantitative ratios. For example, the hardness of the PU elastomer typically increases with increasing content of difunctional chain extenders (c)(i) and trifunctional crosslinking agents (c)(ii). The requisite amounts of synthesis components can be determined experimentally in a simple manner, depending on the desired hardness.

For the production of solid PU elastomers, synthesis component (a) is preferably used in amounts of 30 to 92% by weight, particularly 55 to 90% by weight; synthesis component (b) is preferably used in amounts of 5 to 40% by weight, particularly 7 to 25% by weight, and component (c) is preferably used in amounts of 0.5 to 30% by weight, particularly 1 to 20% by weight, with respect in each case to the totality of the reactive components from which the polymer matrix is synthesised.

For the production of PU elastomers of cellular form, the amount of component (a) is 46 to 94.9% by weight, preferably 65 to 90% by weight, the amount of component (b) is 5 to 40% by weight, preferably 15 to 25% by weight, and the amount of component (c) is 0.1 to 20% by weight, preferably 0.2 to 10% by weight, with respect in each case to the totality of the reactive components from which the polymer matrix is synthesised.

The PU elastomers according to the invention may optionally further contain adjuvant substances and additives which are typically used in polyurethane chemistry. Examples thereof include surface-active substances, fillers, flame retardants, nucleating agents, antioxidants, stabilisers, internal lubricants and demoulding agents, colorants and pigments, as well as foam stabilisers and cell regulators in the case of cellular PU elastomers. In this connection, reference is made to DE-A1-19 627 907, pages 8 and 9.

1,4-naphthalene diisocyanate can be partially replaced by other di- and/or polyisocyanates which are added to the reaction mixture. The amounts of the latter are typically selected so that the viscosities of the prepolymers produced and the mechanical properties of the polyurethane elastomers produced are approximately the same as those produced from 1,4-naphthalene diisocyanate. Other suitable di- and/or polyisocyanates include, but are not limited to, hexamethylene diisocyanate, isophorone disocyanate and p-phenylene diisocyanate, and preferably toluene diisocyanate, and most preferably 1,5-naphthalene diisocyanate and diphenylmethane diisocyanate.

The PU elastomers are preferably produced by what is termed the prepolymer method, in which 1,4-naphthalene diisocyanate is used in the form of a prepolymer which contains isocyanate groups. Said prepolymer can be produced, for example, by the reaction of 1,4-naphthalene diisocyanate with at least one high molecular weight polyhydroxyl compound a) or with a mixture of a) and at least one chain extender and/or at least one crosslinking agent c), or by the step-wise reaction of 1,4-naphthalene diisocyanate, firstly with at least one high molecular weight polyhydroxyl compound a) and subsequently with at least one chain extender and/or crosslinking agent c).

In an embodiment of the present invention, there is provided a method of producing a polyurethane elastomer from reactants comprising:

a) at least one high molecular weight polyhydroxyl compound with a number average molecular weight of 500 to 10,000 and a functionality of at least 1.94;

b) 1,4-naphthalene diisocyanate;

c) at least one of (i) a low molecular weight chain extender and (ii) a crosslinking agent, each of (i) and (ii) independently having at least two hydroxyl groups and having a number average molecular weight of 18 to 499; and

d) optionally foaming agents;

said method comprising,

(I) forming a polyurethane prepolymer by reacting a), b) and optionally a portion of c), said polyurethane prepolymer having a content of free isocyanate groups of 1 to 19% by weight, based on the total weight of said polyurethane prepolymer, and the portion of reactant c) being less than the total weight of reactant c) used in the preparation of the polyurethane elastomer; and

(II) reacting the polyurethane prepolymer of step (I) with the remaining portion of c) and optionally d), (the remaining portion of reactant c) being the difference between the total weight of reactant c) and the weight of the portion of c) used in step 1)

wherein reactants a), b), c) and d) are selected to have an NCO/(active hydrogen group) index of 90 to 130.

The portion of reactant (c), i.e., (c)(i) and/or (c)(ii), that may be used in step (I) of the recited method is typically from 0.1 percent by weight to 20 percent by weight, preferably from 0.2 percent by weight to 10 percent by weight, based on the total weight of reactant (c) that is used in the preparation of the polyurethane elastomer.

A procedure is preferably used here in which said polyol components are reacted with 1,4-naphthalene diisocyanate to form a prepolymer which has a content of isocyanate groups from 1 to 19%, preferably 2 to 10%, particularly 2 to 7%. The isocyanate-terminated prepolymer which is thus obtained is reacted as described above with component c) in a quantitative ratio such that an NCO/(active hydrogen group) index of 90 to 130, preferably 95 to 120, most preferably 100 to 120, is obtained.

Catalysts can optionally also be added, both for the production of the prepolymer and for the reaction of the prepolymer with the aforementioned chain extender and/or crosslinking agent.

In principle, all catalysts which are known in polyurethane chemistry can be used as catalysts for the production both of the prepolymers and of the final PU elastomers. Examples thereof include organic compounds of metals, preferably organic tin compounds, such as tin(II) salts of organic carboxylic acids, e.g. tin(II) acetate, tin(II) octoate, tin(II) ethylhexoate and tin laurate, and dialkyltin(IV) salts of organic carboxylic acids, e.g. dibutyltin diacetate, dibutyltin dilaurate, dibutyltin maleate and dioctyltin diacetate. These organic compounds of metals are used on their own or in combination with strongly basic amines, such as amidines, tertiary amines, tetraalkylenediamines or alkanolamine compounds.

In this connection, reference is made DE-A1-19 627 907, page 7. Moreover, alkali and alkaline earth salts of organic carboxylic acids are also suitable as catalysts.

The catalysts which are used for the production of cellular PU elastomers are preferably sodium and potassium salts of carboxylic acids, for example sodium acetate, potassium acetate, sodium oleate and potassium oleate. The amount of catalyst usually ranges from 0.001 to 3% by weight, preferably 0.001 to 1% by weight, with respect to synthesis components a) +b).

For the production of dense, solid PU elastomers, the reaction of components a) to c) is conducted in the absence of moisture and in the absence of physically or chemically-acting foaming agents. If cellular PU elastomers are to be produced, the reaction of the aforementioned synthesis components is conducted in the presence of a foaming agent (d). Examples of foaming agents (d) which can be used include water or low-boiling liquids which evaporate under the conditions of the exothermic addition polymerisation reaction and which advantageously have a boiling point under normal pressure which is within the range from −40 to 120° C.; gases can also be used as physically-acting foaming agents or as chemically-acting foaming agents. Low boiling liquids can also, of course, be used in combination with water as the foaming agent. The gases, and the liquids of the aforementioned type, which are suitable as foaming agents include all the foaming agents which are known for the production of cellular PU mouldings, for example low-boiling alkanes, ethers and alcohols, as well as the known halogenated, preferably fluorinated, alkanes; gases such as nitrogen, carbon dioxide and inert gases can also be used. Examples of foaming agents which are suitable for the production of cellular PU elastomers are listed in detail in DE-A1-19 627 907, page 8. As mentioned above, the production of solid or cellular

PU elastomers can be effected in a preferred manner by the prepolymer method. It is also possible to produce the PU elastomers by other process techniques which are customary for polyurethanes. Reference is again made to DE-A 19 627 907, pages 9 and 10, for details of methods of production of solid or cellular PU elastomers.

Water is preferably used as a foaming agent.

In the absence of fillers, the solid PU elastomers according to the invention have a density of 1.0 to 1.4 g/cm³, preferably 1.1 to 1.3 g/cm³. Products which contain fillers usually have a density >1.2 g/cm³. The cellular PU elastomers have a density of 0.2 to 1.1 g/cm³, preferably 0.35 to 0.80 g/cm³.

The PU elastomers which are produced by the method according to the invention can be used for the production of molded articles which can withstand high mechanical stresses, and are preferably used in the machine construction and transport sectors, for example as rollers, conveyor belts, gearwheels and seals. The cellular PU elastomers are particularly suitable for the production of damping elements and elastic elements.

The present invention is more particularly described in the following examples, which are intended to be illustrative only, since numerous modifications and variations therein will be apparent to those skilled in the art. Unless otherwise specified, all parts and percentages are by weight.

### EXAMPLES

### Example 1

Production of Prepolymers:

350 g of a polyester of adipic acid and ethylene glycol (Desmophen® 2000 MM, manufactured by Bayer AG) with a number average molecular weight of 2000 g/mol, an OH number of 56 mg KOH/g and an acid number of 0.8 mg KOH/g was placed in a glass beaker with a ground glass joint and dehydrated for 30 minutes at 120° C. and 20 mbar. Next, 63 g of 1,4-naphthalene diisocyanate, or (for the comparative examples) 1.5-diisocyanatonaphthalene (1,5-NDI) was then added with stirring. The reaction mixture was heated to 125-130° C. and stirred for 15 minutes at about 20 mbar.

The viscosity data for prepolymers based on 1,4- (according to the invention) and 1,5- (comparative examples) naphthalene diisocyanate are presented in Table 1.

TABLE 1

| | 1 A | |
|---|---|---|
| Example | (comparison) | 1 B |
| Amount used (g) | | |
| Polyester (Desmophen ® 2000 MM) | 100 | 100 |
| 1,5-diisocyanatonaphthalene (1.5-NDI) | 18 | — |
| 1,4-diisocyanatonaphthalene (1,4-NDI) | — | 18 |
| Temperature [° C.] | Viscosity [mPas] | |
| 125 | 1440 | 850 |
| 120 | 1675 | 1090 |
| 115 | 1860 | 1270 |
| 105 | 2260 | 1640 |
| 100 | 2610 | 1810 |
| 90 | 3600 | 2430 |
| 80 | 5000 | 3430 |
| 75 | 5800 | 4020 |
| 65 | 10000 | 6700 |
| 55 | 18000 | 12400 |

### Example 2

Chain Extenders for the Prepolymers Produced in Example 1

For the reaction with chain extenders, 118 g of a prepolymer mixture which was obtained as in Example 1 and which had been heated to 125-130° C. and stirred for 15 minutes at about 20 mbar was cooled to 120° C., was treated with 2 g 1,4-butanediol and 7 mg dibutyltin dilaurate to effect chain extension, and was stirred for 2 minutes at 20 mbar. The product was then cast into a test piece mould, preheated to 110° C., and was annealed at 110° C. for 15 hours. After demoulding, the test piece was stored for about 30 days at room temperature and was subsequently characterised.

Table 2 lists the mechanical properties determined.

TABLE 2

| Example | 2 A (comparison) | 2 B |
|---|---|---|
| Amount used (g) | | |
| Polyester | 100 | 100 |
| (Desmophen ® 2000 MM) | | |
| 1,5-diisocyanatonaphthalene | 18 | — |
| (1,5-NDI) | | |
| 1,4-diisocyanatonaphthalene | — | 18 |
| (1,4-NDI) | | |
| 1,4-butanediol | 2 | 2 |
| Dibutyltin dilaurate | 0.007 | 0.007 |
| Test piece properties | | |
| Hardness (Shore A) | 80 | 57 |
| Young's modulus, 100% | 3.7 | 1.7 |
| (MPa) | | |
| Young's modulus, 300% | 8.65 | 3.1 |
| (MPa) | | |
| Tensile strength according to | 50 | 40.1 |
| DIN 53 455 (MPa) | | |
| Elongation at break according | 632 | 600 |
| to | | |
| DIN 53 455 (%) | | |
| Tear propagation resistance, | 29 | 29 |
| Graves DIN 53515 (kN/m) | | |
| Rebound resilience | 50 | 52 |
| DIN 53512 (%) | | |
| Compression set (22° C.) | 12.5 | 7.3 |
| DIN 53517 (%) | | |
| Compression set (70° C.) | 20 | 18 |
| DIN 53517 (%) | | |

Results:

The mechanical properties of the cast elastomers produced from the prepolymers according to the invention, which otherwise had the same formulation as that of elastomers based on 1,5-NDI, had lower Shore hardness values and corresponded to the outstanding level of properties of elastomers based on 1,5-NDI.

### Example 3

Production of Prepolymers for Cellular Elastomers

612.5 g of a polyester of adipic acid and ethylene glycol (Desmophen® 2001 KS, manufactured by Bayer AG) with a number average molecular weight of 2000 g/mol, an OH number of 56 mg KOH/g and an acid number of 0.8 mg KOH/g was placed in a glass beaker with a ground glass joint together with 10.23 g castor oil and the mixture was dehydrated for 30 minutes at 120° C. and 20 mbar. Next, 167 g 1,4-naphthalene diisocyanate (for Example 4B according to the invention), or 1,5-diisocyanatonaphthalene (1,5-NDI) (for comparison example 4A) were then added at 150° C. with stirring, whereupon the reaction temperature fell to about 125° C. The reaction mixture was cooled to 110° C. by means of a water bath, and 6.78 g of carbodiimidised 2,5-diisopropylphenyl isocyanate (Stabaxol® 1, manufactured by Rheinchemie) were stirred in. The NCO value was determined as 5.57% by weight. The prepolymers were kept in a recirculating air drying oven at 90° C.

### Example 4

Production of Cellular Elastomers

360.5 g of a prepolymer for cellular elastomer, which was produced as in Example 3, were added at 90° C., together with a mixture of 31.89 g of a polyester of adipic acid, butanediol and ethylene glycol (Desmophen® 2001 KS, manufactured by Bayer AG) with a number average molecular weight of 2000 g/mol, 6.86 g of a 50% aqueous solution of a fatty acid sulphonate (Desmorapid® SM, manufactured by Rheinchemie), 0.69 g of a preparation comprising an amine salt of an alkylbenzene sulphonate; a fatty acid polyglycol ester (Retarder DD 1092, manufactured by Rheinchemie) and 0.07 g N,N-dimethylcyclohexylamine (Desmorapid® 726B, manufactured by Bayer AG) by means of a syringe, and the batch was stirred for 20 seconds at 500 rpm. Next, 305 g of this reaction mixture were cast into a preheated mould (volume: 720 ml) which could be closed. The reaction product was annealed in the closed mould for 16 hours at 110° C. in a recirculating air drying oven.

Physical properties of the cellular elastomers are summarized in Table 3.

TABLE 3
(cellular Elastomer)

| | 4 A | |
|---|---|---|
| Example | (comparison) | 4 B |
| Amount used (g) | | |
| Polyester (Desmophen 2001 KS) | 100 | 100 |
| Castor oil | 1.67 | 1.67 |
| 1,5-diisocyanatonaphthalene (1,6- | 27.26 | — |
| NDI) | | |
| 1,4-diisocyanatonaphthalene (1,4- | — | 27.26 |
| NDI) | | |
| Polyester (Desmophen 2001 KS) | 11.40 | 11.40 |
| Desmorapid SM | 1.22 | 1.22 |
| Water | 1.22 | 1.22 |
| Desmorapid 726B | 0.025 | 0.025 |
| Retarder 1092 | 0.25 | 0.25 |
| Teat piece properties | | |
| Bulk density (g/cm³) | 428 | 435 |
| Hardness (Shore A) | 64 | 60 |
| Young's modulus, 100% (MPa) | 1.56 | 1.18 |
| Young's modulus, 300% (MPa) | 2.66 | 2.11 |
| Tensile strength according to | 2.63 | 2.11 |
| DIN 53 455 (MPa) | | |
| Elongation at break according to | 306 | 301 |
| DIN 53 455 [%] | | |
| Tear propagation resistance, Die | 172 | 181 |
| C [N/cm] | | |
| Rebound resilience [%] | 66 | 64 |

Results:

The mechanical properties of the cellular elastomer produced from the prepolymers according to the invention, which otherwise had the same formulation as that of elastomers based on 1,5-NDI, had somewhat lower Shore hardness values and corresponded to the outstanding level of properties of elastomers based on 1,5-NDI.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyurethane prepolymer prepared from a reaction mixture comprising:
a) at least one high molecular weight polyhydroxyl compound with a number average molecular weight of 500 to 10,000 and a functionality of at least 1.94;
b) 1,4-naphthalene diisocyanate; and
c) optionally at least one of, (i) a low molecular weight chain extender and (ii) a crosslinking agent, each of (i) and (ii) independently having at least two hydroxyl groups and a number average molecular weight of 18 to 499,
wherein said polyurethane prepolymer has a content of free isocyanate groups of 1 to 19% by weight, based on the total weight of said polyurethane prepolymer.

2. A polyurethane elastomer prepared from a reaction mixture comprising:
a) at least one high molecular weight polyhydroxyl compound with a number average molecular weight of 500 to 10,000 and a functionality of at least 1.94;
b) 1,4-naphthalene diisocyanate;
c) at least one of (i) a low molecular weight chain extender and (ii) a crosslinking agent, each of (i) and (ii) independently having at least two hydroxyl groups and a number average molecular weight of 18 to 499; and
d) optionally foaming agents,
wherein said reaction mixture has an NCO/(active hydrogen group) index of from 90 to 130.

3. A method of producing a polyurethane elastomer from reactants comprising:
a) at least one high molecular weight polyhydroxyl compound with a number average molecular weight of 500 to 10,000 and a functionality of at least 1.94;
b) 1,4-naphthalene diisocyanate;
c) at least one of (i) a low molecular weight chain extender and (ii) a crosslinking agent, each of (i) and (ii) independently having at least two hydroxyl groups and having a number average molecular weight of 18 to 499; and
d) optionally foaming agents;
said method comprising,
(I) forming a polyurethane prepolymer by reacting a), b) and optionally a portion of c), said polyurethane prepolymer having a content of free isocyanate groups of 1 to 19% by weight, based on the total weight of said polyurethane prepolymer; and
(II) reacting the polyurethane prepolymer of step (I) with the remaining portion of c) and optionally d),
wherein reactants a), b), c) and d) are selected to have an NCO/(active hydrogen group) index of 90 to 130.

4. A molded article comprising the polyurethane elastomer of claim 2.

5. A method of using the polyurethane prepolymer of claim 1 for the production of molded articles.
